(19) United States
(12) Patent Application Publication
(10) Pub. No.: US 2026/0316360 A1
(43) Pub. Date: Oct. 15, 2026

(54) MOULD-CLOSING UNIT AND METHOD FOR OPERATING THE SAME

(71) Applicant: ARBURG GMBH + CO KG, Lossburg (DE)

(72) Inventor: Rainer BLETSCHER, Baiersbronn (DE)

(21) Appl. No.: 19/479,763

(22) PCT Filed: May 2, 2024
(86) PCT No.: PCT/EP2024/062168

§ 371 Date: Oct. 29, 2025

(30) Foreign Application Priority Data
May 5, 2023 (DE) 10 2023 111 740.8

(51) Int. Cl. B29C 45/67; B29C 45/17; B29C 45/68

(52) U.S. Cl. CPC B29C 45/6728; B29C 45/1744; B29C 45/1761; B29C 45/681; B29C 45/683

(57) ABSTRACT

A mould-closing unit (10) for a machine (100) for processing plastics and other plastifiable materials has a first platen (12), a supporting plate (18), a movable platen (14) and a drive plate (16), wherein the drive plate (16) is located between the movable platen (14) and the supporting plate (18) and wherein at least one series of toggle levers (22, 24) is connected to the supporting plate (18), the drive plate (16) and the movable platen (14) and is supported on the supporting plate (18). The supporting plate (18) has at least one clearance for a guide rod (20), which, during the opening and/or closing of the mould-closing unit (10), passes at least partially through the supporting plate (18). The series of toggle levers (22, 24) are series of toggle levers (22, 24) that swivel out beyond tie bars (30) of the mould-closing unit when the mould-closing unit (10) is being opened. With regard to their articulation, they are arranged within a space bounded by the tie bars (30) at a distance from the bounds of the space inwards in the direction of a central machine axis (axis 40).

### REFERENCE TO RELATED APPLICATIONS

The present application relates to and claims priority from German patent application 10 2023 111 740.8, filed on May 5, 2024, the disclosure of which is hereby expressly, in its entirety, made part of the the subject matter of the present application in its entirety.

The term “mold” as used here relates to an injection mold of the kind conventionally received between the mold carriers of a mold closing unit of a machine for processing plastics. The terms “mold” and “injection mold” are thus used synonymously.

### TECHNICAL FIELD

The disclosure relates to a mold closing unit for a machine for processing plastics and other plasticizable materials, in particular for an injection molding machine, and to a method for operating a mold closing unit.

### BACKGROUND

In injection molding technology, different mold closing units are used with different ranges of closing force. For example, in a closing force range of up to 2,000 kN, five-point toggle levers having an inwardly opening toggle linkage are predominantly known. For example, EP 0 164 419 A1 or DE 10 2015 109 840 B3 disclose closing units having inwardly hinging toggle linkages.

These toggle mechanisms typically take a form having four toggle linkages that are positioned between the movable mold platen and the support carrier. The linkages are connected to the auxiliary and adjusting levers by way of a crosshead and are moved horizontally for example by an electric motor and a spindle. If for example four main levers are used, as the closing force builds up there is a deformation at the points of articulation at the mold plate and/or the support plate, and this results in torsion in the main levers and thus an edge loading on the pivot bearings. Typically, the mounting of the drive plate is always integrated into the adjustment plate, and takes on guidance of the linear movement of the drive plate.

Further, the inward hinging of the toggle linkages takes up room, as a result of which there is little free space for further parts of the machine. Likewise, a corresponding amount of material is used in the formation of the toggle linkages, which is costly in terms of resources.

U.S. Pat. No. 4 545 757 A discloses an injection molding machine having a carrier plate and a movable plate of a mold closing mechanism. The carrier plate is connected to four guide rods, and the movable plate is guided such that it is movable on the guide rods. One end of a central rod guides a movable cross arm, and another end is mounted such that it is movable in the carrier plate. Two toggle linkages are connected, in each case at their center, to the movable cross arm. The carrier plate and movable plate are respectively connected to an end of the two toggle linkages. The movable plate is moved on the guide rods by a hydraulic drive that drives the movable cross arm and hence the toggle linkages. In the open condition of the mold, the toggle levers hinge inward, and in the extended condition the toggle lever points (and the line of force) lie outside the guide rods or tie bars. The geometry of the points at which force is introduced is such that they lie far enough toward the outside that, in the event of hinging inward, the necessary free space is produced for the toggle levers to be able to pivot past one another without colliding. As a result of the fact that the points at which force is introduced are on the outside, the bending beam formed by the mold carriers or mold plate becomes large, and as a result of the construction a large amount of material has to be used in the mold plates in order to generate the same deformation on the mold platen face as in an outwardly hinging system. A central guide that is movably secured to the mold plate provides the mounting for the crosshead and is additionally mounted in the rear carrier plate. This individual guide keeps the crosshead in the central position.

JP H07-205237 A discloses a three-plate mold closing unit in which a rear plate and a movable plate are connected by a mold closing mechanism. The mold closing unit comprises a mold closing drive device and a toggle linkage. The mold closing drive device is equipped with a rotary ball screw and nut and a mold closing motor. The rear end of the toggle linkage is mounted such that it is pivotal on the rear plate and connected thereto. The front end of the toggle linkage is connected to the movable plate, and the central part of the toggle linkage is connected to a crosshead. The crosshead is guided in its longitudinal movement by a guide rod that is arranged parallel to a tie bar, between the movable plate and the rear plate, and is connected to the movable plate.

### BRIEF SUMMARY

The disclosure provides a reliable solution, advantageously as sparing of resources as possible, for a mold closing unit.

The mold closing unit for a machine for processing plastics and other plasticizable materials, in particular for an injection molding machine, has a first mold platen, preferably a stationary mold platen, a support plate, a movable mold platen, and a drive plate, wherein the drive plate is arranged between the movable mold platen and the support plate. At least two toggle linkages, preferably precisely two toggle linkages, are connected to the support plate, the drive plate and the movable mold platen, wherein the toggle linkages are supported against the support plate and are toggle linkages which hinge outward beyond tie bars of the mold closing unit. The term “hinge outward” is used to mean that when the injection mold is opened, starting from the machine center axis, which runs through the first mold platen, the movable mold platen and the support plate in a manner parallel along the tie bars, the toggle linkages open for example upward, downward, rightward and/or leftward, and in so doing extend beyond the plane that is spanned by the tie bars in a projection along an axis in the closing direction. For example, the toggle linkages may hinge downward in the direction of the machine base and upward in the opposite direction, beyond the tie bars. As regards their articulation, they are arranged within a space delimited by the tie bars and at a spacing from the limits of the space, inward in the direction of the machine center axis. This advantageously ensures optimum introduction of force into the movable mold platen, with the result that its construction can be optimized. In this way, material usage is markedly reduced while maintaining the same rigidity. Advantageously, at the same time, as a result of the outward hinging longer strokes can be achieved, since the levers hinge outward from the optimum position, with the result that the levers do not collide.

For a reliable mold closing unit that is advantageously sparing of resources, at least one guide rod, preferably two guide rods, is connected to the movable mold platen and is movable relative to the support plate. The support plate has at least one recess for the at least one guide rod. The recess may take the form for example of an indentation or a hole in the support plate. The at least one guide rod has the function of ensuring precise opening and closing of the mold closing unit as a result of precise guidance of the drive plate. Further, during opening and/or closing of the mold closing unit, the at least one guide rod penetrates at least partly, preferably entirely, through the support plate. For example, in an open condition of the mold closing unit, the at least one guide rod may project entirely through the recess and the support plate. However, it is for example also possible for the at least one guide rod not to project through the support plate in the open condition but for an end of the at least one guide rod to terminate in the at least one recess in the support plate.

Fundamentally, it is also conceivable for the at least one toggle linkage to be supported against the first mold platen and thus for the toggle linkage to draw the movable mold platen, as a result of which a drawing type of mold closing unit is produced. The movable mold platen is then brought closer to the first mold platen.

When the mold closing unit is opened and/or closed, the drive plate is set in motion by way of a drive, for example a hydraulic drive or preferably an electrical drive, for example a spindle drive or a rack-and-pinion drive, as a result of which the toggle linkages are actuated and the movable mold platen is set in motion. When the mold is opened, the drive plate and the movable mold platen move toward the support plate, wherein the at least one guide rod penetrates at least partly, preferably entirely, through the support plate. For example, in the open condition of the mold closing unit, the at least one guide rod can run entirely through the support plate, such that the at least one guide rod is entirely received in the support plate and projects out through the support plate in the opposite direction to the movable mold platen. For this, the support plate has at least one recess, through which the at least one guide rod projects at least partly, preferably entirely, when the mold is in the open condition.

Preferably, the toggle linkages form between them a free space that may advantageously be utilized for the arrangement of the guide rod and/or the installation of peripheral equipment (such as the ejector).

Preferably, for the purpose of advantageous optimal transmission and introduction of force into the movable mold platen, the toggle levers of the toggle linkages are oriented horizontally in the extended position and are at the same time structurally drawn far enough inward for optimal introduction of force to be achieved.

Further preferably, the recess at least partly receives the guide rod and provides the mounting for the guide rod. When the mold is closed, the drive plate is set in motion by way of the drive, and the drive plate and the movable mold platen move toward the first mold platen. The at least one guide rod likewise moves in the direction of the first mold platen. During this, the at least one guide rod now penetrates at least partly out of the support plate, in the direction of the movable mold platen, and/or moves at least partly out of the support plate as the mold closing unit closes. Preferably, in the closed condition of the mold closing unit, the guide rod runs at least partly, more preferably entirely, through the support plate and is at least partly mounted there, but more preferably no longer projects beyond the support plate. However, it is also conceivable for the guide rod to project through or beyond the support plate even in the closed condition of the mold closing unit. Fundamentally, depending on the stroke of the mold closing unit, it is also conceivable for the guide rod to run only partly through the support plate when the mold is open and/or closed, and not to be received over the entire thickness of the support plate or to project through the support plate.

Typically, an outwardly hinging toggle linkage requires a drive plate to be of rather large dimensions, because the auxiliary levers have to be drawn outward. In order advantageously to provide a drive plate that is as compact as possible, the guide for the drive plate has to be positioned in such a way that space for a stationary guide associated with the movable mold platen can only be achieved if it is incorporated into the overall length of the construction. To avoid this, the guide rod is movably associated with the movable mold platen and is arranged in the overall construction such that the guide rod can pass through the support plate (and be guided there), which thus advantageously provides a solution which is sparing of resources in terms of material usage.

As a result of the guide rod being entrained, the sliding speeds of the bearings and guides have relative profiles which, because of the toggle lever kinematics, result in a reduced sliding load on the guide systems. The penetrating guide rod advantageously enables optimum guidance of the drive plate with the outwardly opening toggle linkages with at the same time absolutely minimal material usage. Further, in combination with the outwardly hinging toggle system, long opening strokes are produced with at the same time absolutely minimal material usage and the ideal point of force introduction to the movable mold platen and a large free space, for example for an ejector.

For an advantageously simple geometric solution, preferably the at least one guide rod, more preferably precisely one guide rod, is connected to the center of the movable mold platen. For example, this is particularly advantageous for optimum force application if all the relevant functional units (such as an ejector and/or a drive unit) are eliminated from the central position of the movable mold platen.

Preferably, the at least one guide rod runs through the drive plate and is at least partly mounted in the drive plate and/or the support plate. Advantageously, this results in a lower-speed bearing for the drive plate, and the mounting arrangement is sparing on resources. Further advantageously, mounting the guide rod in the drive plate and/or support plate in each case results in the performance of the opening and/or closing movement of the mold closing unit being stabilized.

For an advantageously reduced sliding load on the guide systems, preferably the at least one guide rod and the movable mold platen on the one hand and the drive plate on the other have, at least at times, a common speed profile during opening and/or closing of the mold closing unit. The speed profile comprises overlaying a movement, preferably a constant movement of a drive, such as a spindle movement or rack-and-pinion movement, on the toggle lever kinematics.

Preferably, during opening and/or closing of the mold closing unit the at least one guide rod and the movable mold platen move, over at least a period of time, at the same speed as the drive plate, or at a speed that is identical to it at least at one point in time. Advantageously, this reduces friction and hence wear in relation to the guide rod and the drive plate and in relation to the corresponding bearings and guides. Further advantageously, this results in a toggle-lever mold closure with fewer lubrication points. Because the frictional force is proportional to the speed V or is a function of V², friction is advantageously reduced, as a result of which wear is minimized. For example, the mounting of the guide rod, such as a slide bearing, is not under load at a relative speed of zero.

Preferably, during opening and/or closing of the mold closing unit the speed of the drive plate is substantially constant over at least a period of time. Advantageously, this results in a mounting that is sparing on resources, since friction from changes in speed occurs for example at the guide rod.

Advantageously in respect of reducing the effects of torsion on the toggle pivot joints, at least two toggle linkages, more preferably precisely two toggle linkages, are each arranged with one end acting centrally, preferably horizontally centrally, and/or vertically symmetrically on the movable mold platen. Further preferably, the other ends of the toggle linkages may be arranged to act centrally, preferably horizontally centrally, and/or vertically symmetrically on the support plate. The term “horizontally centrally” means, for example in the case of a substantially rectangular movable mold platen, that the toggle linkages are arranged along the vertical center line of the movable mold platen—the spacing from the edge of the movable mold platen to left and right is substantially the same. In this example, the toggle linkages are then arranged above and below one another along the vertical center line. The term “vertically symmetrically” means, in this example, that the symmetry relative to the horizontal center line of the substantially rectangular movable mold platen comprises the axis of symmetry, and so the toggle linkages have substantially the same spacing from the horizontal center line vertically upward and downward. Further advantageously, this results in a simplified measurement of closing force at the tie bars, since these serve merely as tension rods. Further, the toggle linkages may be connected to the support plate at the respectively other end.

Further preferably, precisely two toggle linkages are provided, wherein the toggle linkages are respectively arranged with one end acting horizontally centrally and vertically symmetrically in the upper and lower half of the movable mold platen. For example, in the case of a substantially rectangular movable mold platen, the horizontal center line delimits the upper and lower half. Because of the central introduction of force next to a free space, for example for a centrally positionable ejector, the central arrangement of the toggle linkages and the outward hinging of the toggle linkages advantageously also provides optimized introduction of force from the toggle linkage to the movable mold platen and ultimately to the mold.

Further preferably, the precisely two ends of the toggle linkages that are arranged to act horizontally centrally and vertically symmetrically on the movable mold platen are at the smallest possible spacing from one another. The position, preferably the symmetrical position, of the ends of the toggle linkages may depend on an installed part, such as an ejector, that is provided in the central region of the movable mold platen. In the absence of an ejector, the one ends of the toggle linkages may for example be arranged horizontally centrally and vertically symmetrically in the upper and lower half of the movable mold platen such that the respective ends of the toggle linkages are directly adjacent to each another. In that case, the ends of the toggle linkages are arranged as close to one another as possible and adjoin one another. For example, in the case of one conventional central cavity, the toggle linkages may be pushed together to the maximum extent, wherein the toggle linkage is then located for example in a spacing range of 0-50% of the clearance between the tie bars. In the case of two or more cavities, the position is arranged as an extension to the external cavity, wherein the toggle linkage is located for example in a spacing range of 0-50% of the clearance between the tie bars. Advantageously this results in a uniform transmission of force in respect of the complete movable mold platen.

Further preferably, the ends of the toggle linkages that are arranged to act on the movable mold platen are displaceable, more preferably steplessly displaceable. In the case of outwardly hinging toggle linkages, the ends of the toggle linkages that are arranged to act on the movable mold platen may be pushed together, more preferably pushed completely together, advantageously resulting in flexible positioning of the toggle linkages. For example, in the case of a substantially rectangular movable mold platen, ends of the toggle linkages that are arranged to act on it horizontally centrally and vertically symmetrically may be displaced, more preferably steplessly displaced, along the horizontal center line. Further preferably, the other ends of the toggle linkages, which are connected to the support plate, may also be displaceable, more preferably steplessly displaceable. Further preferably, in this way the complete toggle linkage may also be displaceable, even more preferably steplessly displaceable.

If the number of toggle linkages used is preferably reduced for example from four to two, advantageously this provides the possibility of shaping the drive plate such that the drive plate, by way of guidance by the guide rods, enables an outwardly directed toggle movement without having any effect on the length determined for the overall construction. In addition to the advantageous saving on weight of about 25% with the same rigidity of the closing components, further positive properties are produced for the load on the toggle pivot systems and the sliding speed of the guide systems.

Preferably, at least two guide rods, more preferably precisely two guide rods, are provided that are preferably arranged centrally, preferably vertically centrally, and/or horizontally symmetrically on the movable mold platen. While a single central guide cannot prevent rotation or tilting of the crosshead and/or movable mold platen, when there is a plurality of guide rods the drive plate is guided, and may advantageously compensate in a more optimal manner for forces acting asymmetrically as a result of the arrangement of the guide rods and ensures, as a result of the positive orientation of the drive plate position, that even under high asymmetric forces the points of toggle lever articulation are not deformed and there are no edge loadings in the high-load toggle pivot joint, something which is of critical importance from a technical point of view. Double or multiple guidance advantageously improves behavior under asymmetrical forces.

The term “vertically centrally” means, for example in the case of a substantially rectangular movable mold platen, that the guide rods are arranged along the horizontal center line of the movable mold platen and are thus at substantially the same spacing upward and downward from the edge of the movable mold platen. The term “horizontally symmetrically” means, in this example, that the symmetry relative to the vertical center line of the substantially rectangular movable mold platen comprises the axis of symmetry, and so the guide rods have substantially the same spacing from the vertical center line horizontally to left and right. Because of the very compact symmetrical arrangement of the guide rods outside the drive plate center, there are clear advantages for thermal expansion, because as a result the spacing between the guide and the center can be kept small. For example in the case of a rectangular movable mold platen, the guide rods are arranged along the horizontal center line and symmetrically with respect to the vertical center line, as the axis of symmetry. Preferably, the at least two guide rods are each at the smallest possible spacing from the center of the drive plate and/or the movable mold platen, as a result of which there are advantages in relation to the thermal properties of the guide rods. Thermal expansion is physically dependent on the effect of temperature and the length L, that is to say the closer the guide rods are to one another the smaller the free length L and thus naturally also the smaller the deflection of the guide rod bore from the ideal position. The closer to the center the guide rods and guide rod bores are positioned, the smaller the thermal expansion and thus the smaller the deviation in position of the guide rod bores from the ideal position.

Further preferably, the at least two guide rods, preferably the precisely two guide rods, lie in a horizontally symmetrically band of 0-100%, preferably 20-80% of the clearance between the tie bars, wherein further preferably a guide rod spacing of 0-100%, preferably 20-80% of the clearance between the tie bars is advantageous for precise and stable guidance.

Advantageously for extending the possibilities for the mold closing unit, preferably the at least one guide rod is part of a closing stroke safety mechanism. Preferably, in addition to the tasks of guidance, the penetrating guide rod provides further ways to integrate further functions, such as a mechanical closing stroke safety mechanism such as a ramming rod.

Preferably, at least two toggle linkages and at least two guide rods are provided and are arranged at a right angle to one another on the movable mold platen, the support plate and/or the drive plate. The phrase “arranged at a right angle” is to be understood to mean that two guide rods are arranged horizontally symmetrically and vertically centrally for example at the movable mold platen, while the toggle linkages are correspondingly arranged at a right angle thereto, that is to say horizontally centrally and vertically symmetrically. If for example the points at which the toggle linkages are arranged at the movable mold platen and the points at which the guide rods are connected at the movable mold platen are connected to one another, then the connections intersect substantially at a right angle. This advantageously results in direct introduction of force into the mold with at the same time stable mounting.

Further preferably, precisely two toggle linkages and precisely two guide rods are provided and are arranged at a right angle to one another at the movable mold platen, the support plate and/or the drive plate. If for example the points at which the two toggle linkages are arranged are connected to one another by a line, and the points at which the two guide rods are arranged are connected to one another by a line, then the two connection lines intersect at a right angle. This advantageously results in savings on material with at the same time sufficient and stable introduction of force into the mold.

The disclosure provides moreover a method for operating a mold closing unit for a machine for processing plastics and other plasticizable materials, in particular for an injection molding machine. This produces advantages in respect of material usage and an operation that is sparing of resources, since the mold closing unit can take a more compact form because of the movable guidance. For this, the movable mold platen is actuated by the toggle linkages, within a space delimited by the tie bars and at a spacing from the limits of the space, inward in the direction of a machine center axis.

Preferably, during opening and/or closing of the mold closing unit the at least one guide rod and the movable mold platen move, over at least a period of time, at the same speed as the drive plate. Advantageously, this produces advantages in terms of security and wear, since changes in speed result in friction, for example at the guide rod, which is disadvantageous for the corresponding bearings and guides. Further advantageously, this results in reduced lubrication of the toggle-lever mold closure.

In the event of changes in speed, as a result of the friction for the required acceleration there is a disadvantageous wear to the elements affected by friction. In order to bring about advantages in respect of friction and the concomitant wear, during opening and/or closing of the mold closing unit the drive plate is moved, over at least a period of time, at a substantially constant speed.

The features listed individually are combinable, where this is technologically meaningful, and may be supplemented by explanatory information from the description and details from the Figures, with further variant embodiments being indicated.

### BRIEF DESCRIPTION OF THE FIGURES

The disclosure is explained in more detail below with reference to exemplary embodiments represented in the attached Figures, in which the Figures show:

FIG. 1 an isometric view from the left of a machine for processing plastics and other plasticizable materials (mold closed),

FIG. 2 an isometric view from the left of a machine according to FIG. 1 (mold open),

FIG. 3 an isometric view from the right of the machine according to FIG. 1 (mold closed),

FIG. 4 an isometric view from the right of the machine according to FIG. 3 (mold open),

FIG. 5 a vertical section through the machine longitudinal axis (mold closed),

FIG. 6 a horizontal section through the machine (mold closed),

FIG. 7 a horizontal section through the machine (mold open),

FIG. 8 a side view of a mold closing unit,

FIG. 9 shows a section along the axis D-D in FIG. 8, through the auxiliary and adjusting toggle levers, and

FIG. 10 shows a graph of the speed v of the mold plate or movable mold platen and drive plate over time t.

### DETAILED DESCRIPTION OF PREFERRED EXEMPLARY EMBODIMENTS

The disclosure is now explained in more detail by way of example, with reference to the attached drawings. However, the exemplary embodiments are only examples, which are not intended to restrict the concept to a particular arrangement. Before the disclosure is described in detail it should be pointed out that it is not restricted to the respective structural parts of the device and the respective method steps, since these structural parts and method may vary. The terms used here are merely intended to describe particular embodiments and are not used restrictively. Moreover, where the singular or the indefinite article is used in the description or the claims, this also refers to a plurality of these elements unless the overall context unambiguously indicates otherwise.

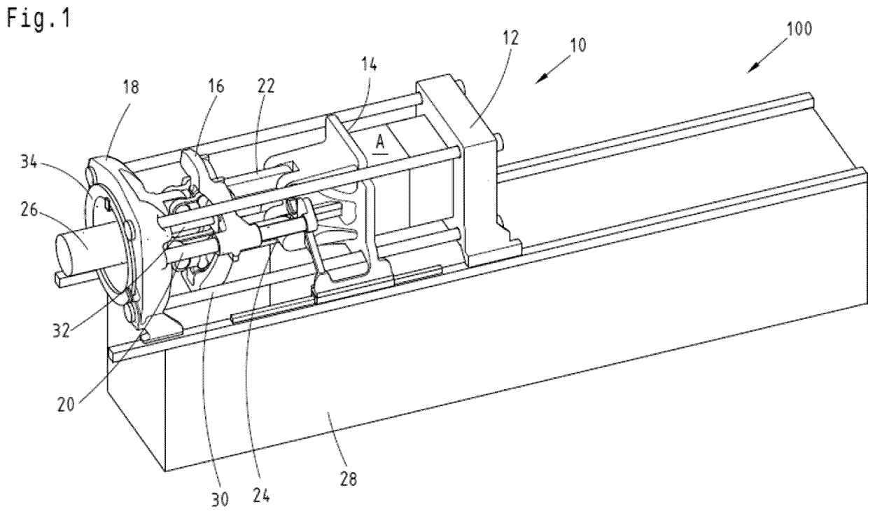

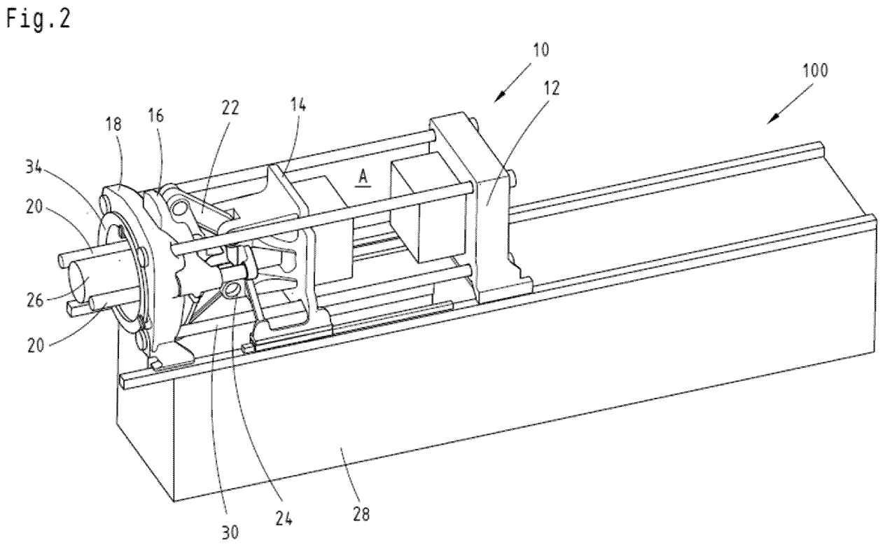

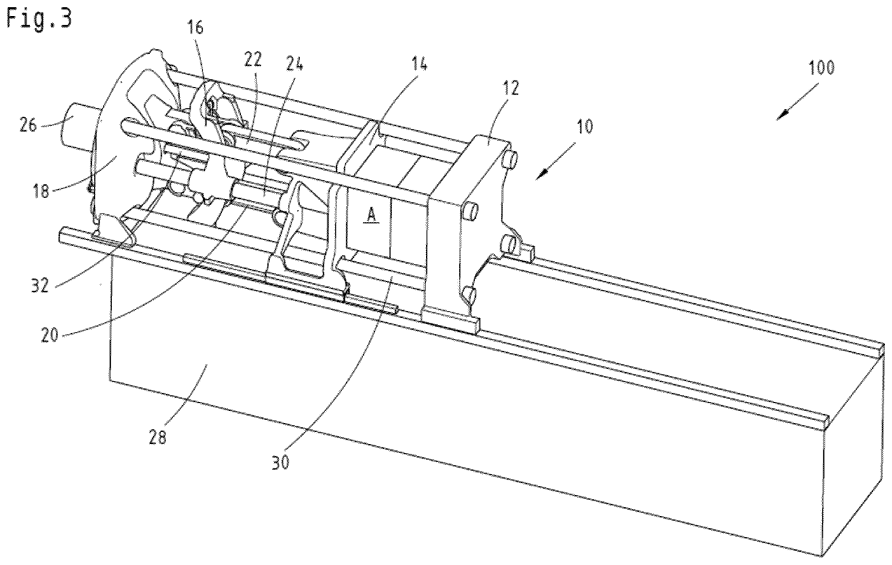

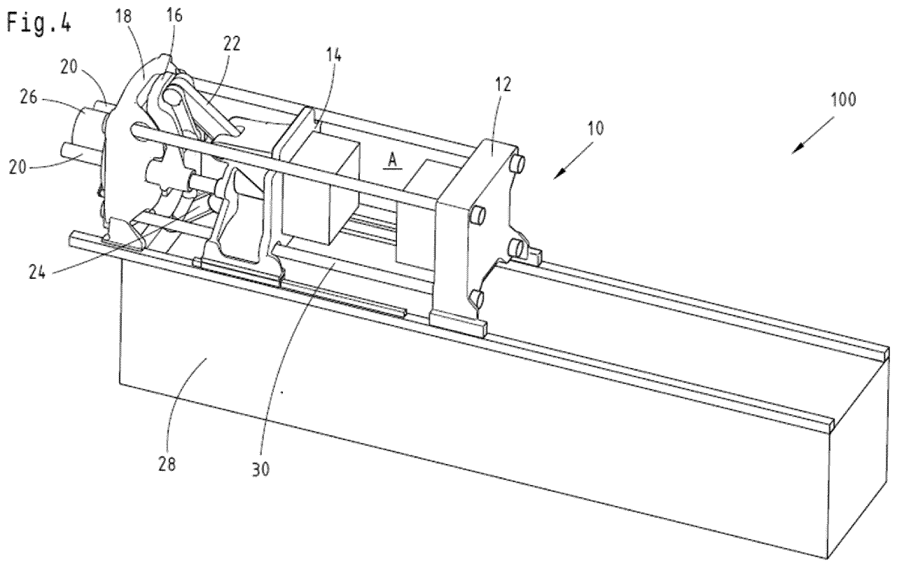

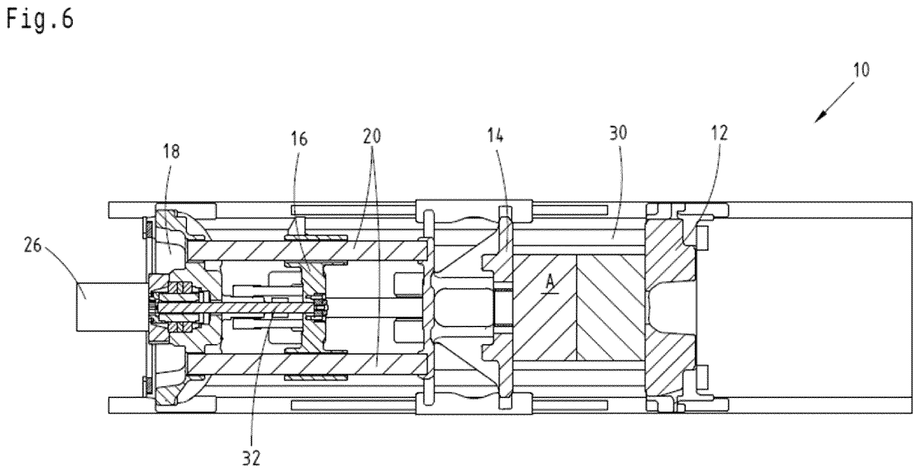

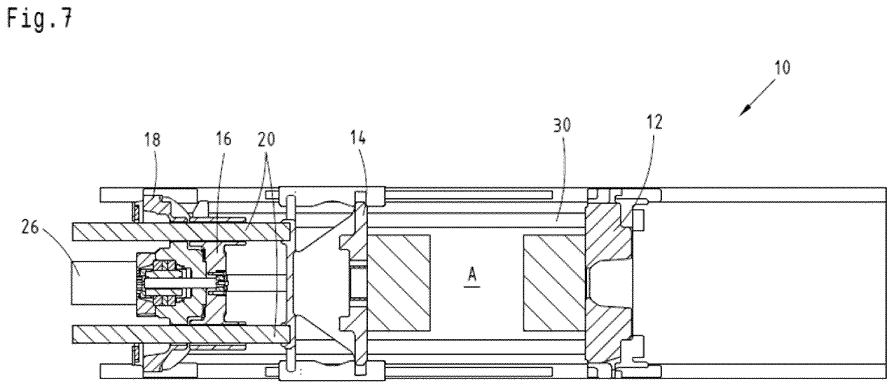

The exemplary embodiment according to FIGS. 1, 3, 5, 6, 8 and 9 shows a machine 100 for processing plastics and other plasticizable materials, in particular an injection molding machine, which has an injection unit (not illustrated) and a mold closing unit 10 in a closed condition of an (injection) mold, in various views. FIGS. 2, 4 and 7 show the machine 100 and the mold closing unit 10 in an open mold condition, in various views. The mold closing unit 10 and/or the injection unit may be arranged on a machine base 28. In FIG. 1, the mold closing unit 10 is arranged for example on the left-hand side with a mold cavity A for a mold, and the injection unit (not illustrated) is arranged on the right-hand side.

The mold closing unit 10 has a first mold platen 12, in FIG. 1 a stationary mold platen, a movable mold platen 14, a support plate 18, and a drive plate 16 which is arranged between the movable mold platen 14 and the support plate 18. In FIGS. 1-9, the mold closing unit 10 has tie bars 30 that connect the support plate 18 and the first mold platen 12. A plurality of toggle linkages 22, 24, in FIG. 1 two toggle linkages 22, 24, are connected to the support plate 18, the drive plate 16 and the movable mold platen 14, wherein the toggle linkages 22, 24 are supported against the support plate 18 and take the form of outwardly hinging toggle linkages 22, 24. In this context, when the injection mold is opened, starting from the machine center axis (axis 40) the toggle linkages 22, 24 are hinged outward, for example upward, downward, to the right and/or to the left, beyond the plane that is spanned by the tie bars 30 in a projection of the center axis in the closing direction. For example, the toggle linkages may be hinged downward in the direction of the machine base and upward in the opposite direction, beyond the tie bars.

As regards articulation of the toggle linkages 22, 24, the points of articulation at the movable mold platen 14 are arranged within a space delimited by the tie bars 30 and at a spacing from the limits of the space, inward in the direction of the axis 40. This advantageously ensures optimum introduction of force into the movable mold platen 14, with the result that its construction can be optimized. In this way, material usage is markedly reduced while maintaining the same rigidity. Advantageously, at the same time, as a result of the outward hinging longer strokes can be achieved, since the toggle levers hinge outward out of the extended position from the optimum position, with the result that the levers do not collide.

This arrangement has the effect that the toggle linkages 22, 24 form between them a free space that may advantageously be utilized for the arrangement of the guide rod 20 and/or the installation of peripheral equipment (such as the ejector).

Preferably, for the purpose of advantageous optimal transmission and introduction of force into the movable mold platen, the toggle levers of the toggle linkages are oriented horizontally in the extended position and are at the same time structurally drawn far enough inward for optimal introduction of force to be achieved.

The drive plate 16 is driven and moved by way of a drive 26, such as a spindle drive, a rack-and-pinion drive or a hydraulic drive, and by way of a drive rod 32, such as a spindle, a rack-and-pinion mechanism or a piston. At least one guide rod 20, in FIG. 1 two guide rods 20, are connected to the movable mold platen 14 and are movable relative to the support plate 18. Further, the support plate 18 has at least one recess, in FIG. 1 two recesses, for the two guide rods 20, wherein when the mold closing unit 10 is open and/or closed the guide rods 20 penetrate at least partly, preferably entirely, through the support plate 18. Optionally, the mold closing unit 10 may have a mold height adjustment mechanism 34 on the support plate 18.

During the procedure of opening and/or closing the mold closing unit 10, the drive plate 16 is set in motion by way of the drive 26 and the drive rod 32, as a result of which the toggle linkages 22, 24 are actuated and the movable mold platen 14 and the guide rods 20 are set in motion. For example, in the closed condition of the mold closing unit 10 according to FIG. 1, the guide rods 20 run at least partly, preferably entirely, through the support plate 18 but no longer project out of the support plate 18. The guide rods 20 may run through the entire thickness or part of the thickness of the support plate 18. However, it is also conceivable for the guide rods 20 to project out through the support plate 18 in the direction of the drive 26 in the closed condition of the mold closing unit 10 as well. The support plate 18 has corresponding recesses which at least partly, preferably entirely, receive and provide a mounting for the guide rods 20.

When the mold or the mold closing unit 10 is opened, by way of the drive 26 and the toggle linkages 22, 24 the drive plate 16 and the movable mold platen 14 move toward the support plate 18, wherein the guide rods 20 penetrate through the support plate 18.

In FIGS. 2, 4 and 7 the machine 100 is shown with an open mold. For example, the guide rods 20 in FIG. 2 project longitudinally beyond the support plate 18 in the direction of the drive 26. Fundamentally, it is also conceivable for the guide rods 20 not to project out through the support plate 18 in the open condition of the mold closing unit 10.

When the mold or the mold closing unit 10 is closed again, by way of the drive 26 and the toggle linkages 22, 24 the drive plate 16 and the movable mold platen 14 move toward the first mold platen 12, wherein the guide rods 20 pass through the support plate 18 but now in the other direction from when the mold closing unit 10 was opened. The guide rods 20 come practically out of the support plate 18 in the direction of the first mold platen 12.

In FIGS. 1 to 9, the guide rods 20 run through the drive plate 16 and are at least partly mounted in the drive plate 16 and/or the support plate 18. For example, in FIG. 2 the guide rods 20 run through the drive plate 16 and the support plate 18 and are likewise mounted there. In the condition in which the mold is closed (FIGS. 1, 3, 5, 6, 8 and 9), the guide rods 20 run at least partly through the support plate 18, while in the condition in which the mold is open (FIGS. 2, 4 and 7) the guide rods 20 penetrate through the support plate 18 and project out of the support plate 18 in the direction of the drive 26.

During opening and/or closing of the mold closing unit 10, the guide rods 20 and the movable mold platen 14 on the one hand and the drive plate 16 on the other have, at least at times, a common speed profile. The speed profile comprises overlaying a constant movement of the drive 26, such as a constant spindle movement, on the toggle lever kinematics.

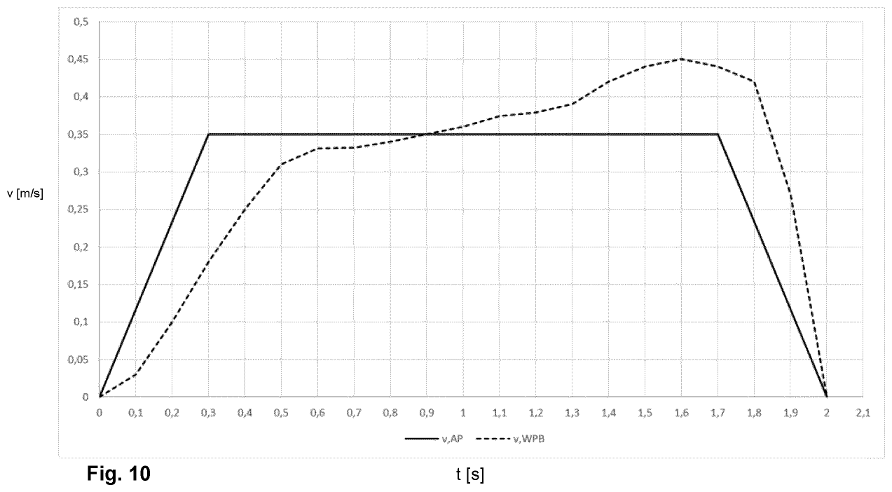

The graph according to FIG. 10 shows the speed profiles of the mold plate or movable mold platen 14 (dotted line) and the drive plate 16 (solid line). Because the movable mold platen 14 and the guide rods 20 are fixedly connected to one another, the speed profile of the movable mold platen 14 is also the speed profile of the guide rods 20. The abbreviation v,AP stands for the speed of the drive plate 16 (crosshead), and the abbreviation v,WPB stands for the speed of the movable mold platen 14. The time t is shown in seconds on the X axis, and the speed v is shown in meters per second on the Y axis.

The drive plate 16 is moved at a continuous speed profile (with a plateau) by the drive unit. Because of the toggle lever kinematics and the consequent translational movement, the movable mold platen 14 and the drive plate 16 move at identical speeds at preferably precisely one point in time (at t=0.9 sec), that is to say that the relative speed between the two components is zero at this point. Fundamentally, however, the two components may also move at the same speed, that is to say at an almost similar speed, over a particular period of time.

Within the plateau region of the speed v, AP of the drive plate 16, from approximately t=0.5 sec to approximately t=1.4 sec, the speed profiles of the two plates are almost identical. Thus, the relative load on the slide mounting between the guide rod 20 (which moves at the same speed as the movable mold platen 14 because they are fixedly connected) and the drive plate 16 is to a considerable extent minimized.

During opening and/or closing of the mold closing unit 10 the guide rods 20 and the movable mold platen 14 move, over at least a period of time, at the same speed as the drive plate 16.

For advantageously wear-free operation of the mold closing unit over at least a period of time during opening and/or closing of the mold closing unit 10, the relative speed between the movable mold platen 14 and the guide rods 20 on the one hand and the drive plate 16 on the other is equal to zero. The drive plate 16 and the movable mold platen 14 are moved by the drive 26 and by way of the toggle linkages 22, 24. Movement of the movable mold platen 14 follows movement of the drive plate 16 by way of the toggle linkages 22, 24 (there is no direct connection between the drive plate 16 and the movable mold platen 14-the connection is made by way of the toggle linkages 22, 24), wherein the relative speed between the movable mold platen 14 and the guide rod 20 and the drive plate 16 is equal to zero over at least a period of time, as a result of which advantageously a bearing arrangement that is sparing on resources is produced.

Further, during opening and/or closing of the mold closing unit 10 the speed of the drive plate 16 is substantially constant. Only for a short time during acceleration and deceleration of the drive plate 16 does the speed of the drive plate 16 change, whereas it is substantially constant substantially during the opening and/or closing procedure of the mold closing unit 10. When for example the mold closing unit 10 is opened, the drive plate 16 is moved, in FIG. 1 for example to the left, by the drive 26, wherein after a particular time the movable mold platen 14 is set in motion by way of the toggle linkages 22, 24. After a certain point in time, the drive plate 16 and the movable mold platen 14 are then moved at the same constant speed over at least a period of time before movement of the drive plate 16 slows, with the result that the mold closing unit 10 is in the open mold condition (for example FIG. 2).

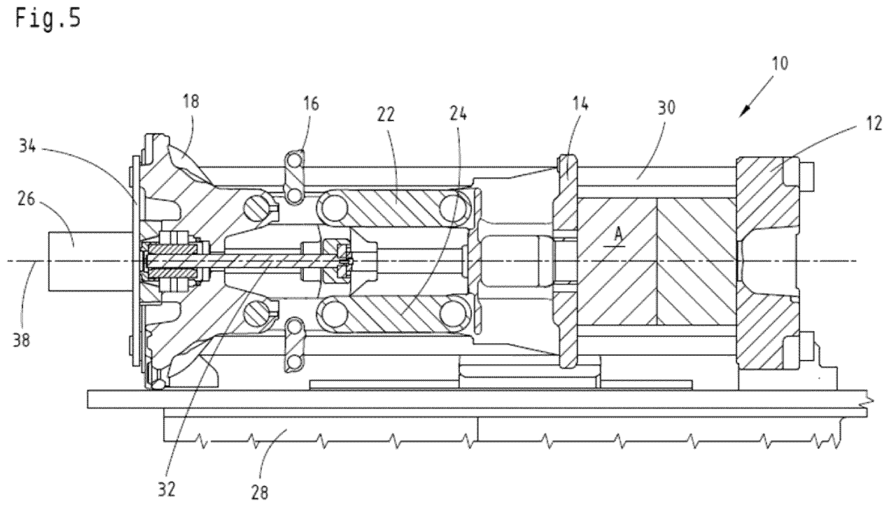

According to FIGS. 1 to 9, the two toggle linkages 22, 24 are arranged to act on the movable mold platen 14 centrally, in FIGS. 1 to 9 horizontally centrally, and vertically symmetrically. In FIG. 5, for example, a vertical section through the machine longitudinal axis is illustrated in the condition in which the mold is closed. There, the two toggle linkages 22, 24 are arranged to act on the movable mold platen 14 horizontally centrally, that is to say the spacing to “left” and “right” is the same (see also FIG. 9), and vertically symmetrically, that is to say that a respective toggle linkage 22, 24 is located at the same spacing “above” and “below” the axis of symmetry 38 or the horizontal plane through the axis of symmetry 38. Further, FIG. 5 shows that the toggle linkages 22, 24 are likewise arranged centrally, preferably horizontally centrally, and/or vertically symmetrically against the support plate 18.

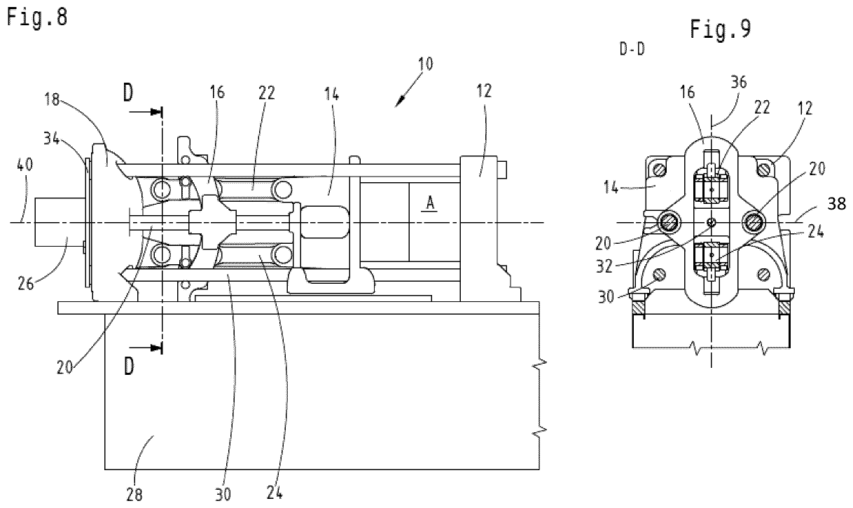

According to FIGS. 1-9, precisely two toggle linkages 22, 24 are provided, wherein the toggle linkages 22, 24 are arranged horizontally centrally and vertically symmetrically in the upper and lower half of the movable mold platen 14. For example, in FIG. 8 or 9 the axis 40 delimits an upper and a lower half of the movable mold platen 14. There, the toggle linkages 22, 24 are arranged substantially horizontally centrally and vertically symmetrically in the upper and lower half of the movable mold platen 14.

According to FIGS. 1-4, the toggle linkages 22, 24 take a symmetrical form within their own horizontal and/or vertical configuration. In FIG. 5, for example, the toggle linkages 22, 24 themselves take a horizontally and vertically symmetrical form. There, it is discernible for example in relation to the upper toggle linkage 22 that the lever element on the right-hand side, which acts on the movable mold platen 14, is cut through in the center and the lever element on the left-hand side, which is connected to the support plate 18, is not cut through, since there is a further lever element parallel to the axis of section.

In FIGS. 1 to 9, precisely two guide rods 20 are provided, and these are arranged vertically centrally and horizontally symmetrically against the movable mold platen 14. For example, in FIG. 9 the guide rods 20 are arranged vertically in the center, along the axis 40, and horizontally symmetrically in relation to the vertical axis of symmetry 36, that is to say there is a respective guide rod 20 at the same spacing to left and right of the axis of symmetry 36.

Further, in FIGS. 1-9 two toggle linkages 22, 24 and two guide rods 20 are provided and are arranged at a right angle to the movable mold platen 14, the support plate 18 and/or the drive plate 16 respectively. If for example in FIG. 9 the points at which the toggle linkages 22, 24 are arranged are connected to one another, which results in a connection along the axis of symmetry 36, and the points at which the guide rods 20 are arranged are connected to one another, which results in a connection along the axis 40, then the connections or the axis of symmetry 36 and the axis 40 intersect at a right angle.

In a further preferred exemplary embodiment, the two guide rods 20 have the smallest possible spacing between the guide rods 20 and the center of the drive plate 16, resulting in clear advantages in respect of thermal expansion, since the thermal expansion is proportional to the rise in temperature and the spacing. The spacing between the guide rods 20 has been made geometrically as small as possible in order to keep thermal expansion advantageously small.

In a further preferred exemplary embodiment, the at least one guide rod 20 is part of a closing stroke safety mechanism. The closing stroke safety mechanism may for example take the form of a ramming rod. If for example two guide rods 20 are provided, it is conceivable for each guide rod 20 to take the form of a ramming rod of a closing stroke safety mechanism.

It goes without saying that this description may be subject to the most diverse modifications, changes and adaptations which are within the range of equivalents to the attached claims.

1. Mold closing unit for a machine for processing plastics and other plasticizable materials comprising:
a first mold platen,
a support plate,
a movable mold platen, and
a drive plate,
wherein the drive plate is arranged between the movable mold platen and the support plate,
wherein a plurality of toggle linkages are connected to the support plate, the drive plate and the movable mold platen and are supported against the support plate, and
wherein at least one guide rod is connected to the movable mold platen and is movable relative to the support plate, and
wherein the support plate has at least one recess for the at least one guide rod and, during at least one of opening or closing of the mold closing unit, the at least one guide rod penetrates at least partly through the support plate,
wherein the toggle linkages are toggle linkages which, when the mold closing unit is opened, hinge outward beyond tie bars of the mold closing unit and which, as regards their articulation, are arranged within a space delimited by the tie bars and at a spacing from the limits of the space, inward in the direction of a machine center axis,
wherein the toggle linkages form between them a free space,
wherein the toggle levers of the toggle linkages are oriented horizontally in the extended position, and
wherein the at least one guide rod runs through the drive plate and is at least partly mounted in at least one of the drive plate or the support plate.

2.-4. (canceled)

5. Mold closing unit as claimed in claim 1, wherein during the at least one of the opening or the closing of the mold closing unit the at least one guide rod and the movable mold platen move, over at least a period of time, at the same speed as the drive plate, or at a speed that is identical to it at least at one point in time.

6. Mold closing unit as claimed in claim 1, wherein during the at least one of the opening or the closing of the mold closing unit the speed of the drive plate constant over at least a period of time.

7. Mold closing unit as claimed in claim 1, wherein the toggle linkages are each arranged with one end acting at least one of centrally or vertically symmetrically on the movable mold platen.

8. Mold closing unit as claimed in claim 7, wherein the ends of the toggle linkages that are arranged to act on the movable mold platen are displaceable.

9. Mold closing unit as claimed in one of the preceding claims claim 1, wherein at least two guide rods are provided that are preferably arranged at least one of centrally and/or horizontally symmetrically on the movable mold platen.

10. Mold closing unit as claimed in claim 1, wherein the at least one guide rod is part of a closing stroke safety mechanism.

11. Mold closing unit as claimed in claim 1, wherein the toggle linkages and at least two guide rods are provided and are arranged at a right angle to one another on at least one of the movable mold platen or the support plate and/or the drive plate.

12. Method for operating a mold closing unit for a machine for processing plastics and other plasticizable materials, comprising a first mold platen, a support plate, a movable mold platen, and a drive plate, the method comprising:
arranging the drive plate between the movable mold platen and the support plate,
connecting a plurality of toggle linkages to the support plate, to the drive plate and to the movable mold platen, and are supported against the support plate, and
connecting at least one guide rod to the movable mold platen and, during at least one of opening or closing of the mold closing unit, the guide rod moves relative to the support plate and at least partly is penetrated through the support plate,
wherein, when the toggle linkages are hinged closed and the mold closing unit is opened, the toggle linkages hinge outward beyond tie bars of the mold closing unit and the movable mold platen is actuated by the toggle linkages within a space delimited by the tie bars and at a spacing from the limits of the space, inward in a direction of a machine center axis,
wherein the toggle linkages form between them a free space,
wherein the toggle levers of the toggle linkages are oriented horizontally in the extended position, and
wherein the at least one guide rod runs through the drive plate and is at least partly mounted in at least one of the drive plate or the support plate.

13. Method as claimed in claim 12, wherein during the at least one of the opening or the closing of the mold closing unit the at least one guide rod and the movable mold platen are moved, over at least a period of time, at the same speed as the drive plate.

14. Method as claimed in claim 12, wherein during the at least one of the opening and/or the closing of the mold closing unit the drive plate is moved, over at least a period of time, at a constant speed.
